(19) United States
(12) Patent Application Publication
(10) Pub. No.: US 2007/0012899 A1
(43) Pub. Date: Jan. 18, 2007

(54) Phosphate dispersant, paste composition and dispersion method using the same

(75) Inventors: Eun-sung Lee, Yongin-si (KR); Jae-young Choi, Suwon-si (KR); Seon-mi Yoon, Yongin-si (KR); Seul-ki Kim, Yongin-si (KR); Jun-hee Kim, Suwon-si (KR); Jong-gab Baek, Hwaseong-si (KR)

Correspondence Address: BUCHANAN, INGERSOLL & ROONEY PC, POST OFFICE BOX 1404, ALEXANDRIA, VA, 22313-1404, US

(73) Assignee: Samsung Electro-mechanics Co., Ltd., Suwon-si (KR)

(21) Appl. No.: 11/319,448

(22) Filed: Dec. 29, 2005

(30) Foreign Application Priority Data
Jul. 15, 2005 (KR) 10-2005-0064160

(51) Int. Cl. H01B 1/12

(52) U.S. Cl. 252/500

(57) ABSTRACT

A phosphate dispersant which can improve the efficiency of dispersing nickel metal powder by effectively adsorbing on the surface of the metal powder and preventing aggregation thereof, and a paste composition and a dispersion method using the same are provided. A multilayer ceramic capacitor (MLCC) is also provided. The phosphate dispersant can achieve the optimal dispersion efficiency by strongly adsorbing on the surface of the nickel metal powder. An improvement in the dispersion efficiency as such can consequently suppress aggregation of the nickel metal powder during the preparation of a conductive paste composition containing a nickel metal powder, and therefore a larger amount of the nickel metal powder can be used in the paste composition. The increased amount of nickel metal powder allows producing an internal nickel electrode having improved electric properties and mechanical properties during the production of MLCCs.

### CROSS-REFERENCE TO RELATED PATENT APPLICATION

This application claims the benefit of Korean Patent Application No. 10-2005-0064160, filed on Jul. 15, 2005, in the Korean Intellectual Property Office, the disclosure of which is incorporated herein in its entirety by reference.

### BACKGROUND OF THE DISCLOSURE

1. Field of the Disclosure

The present disclosure relates to a phosphate dispersant, and a paste composition and a dispersion method using the same, and more particularly, to a phosphate dispersant which improves the efficiency of dispersing metal powder by effectively adsorbing on the surface of the metal powder and preventing aggregation of the metal powder, and a paste composition and a dispersion method using the same. The invention also relates to a multilayer ceramic capacitor (MLCC).

2. Description of the Related Art

A multilayer ceramic condenser (hereinafter, referred to as MLCC) is produced by laminating a plurality of dielectric thin layers and a plurality of internal electrodes. An MLCC with this structure has a large capacitance relative to its small volume, and thus, is widely used in a variety of electronic appliances such as, for example, personal computers and mobile telecommunication devices.

A silver-palladium (Ag—Pd) alloy has been used as the material for the internal electrode, which constitutes the MLCC. The silver-palladium alloy can be easily applied to the production of MLCCs since the alloy can be sintered even in the atmospheric air; however, the alloy is expensive and the economics are not favorable. In order to lower the cost of the MLCCs, there was an attempt in the latter half of 1990's to replace the silver-palladium alloy with inexpensive nickel for the material of the internal electrode. Accordingly, nickel electrodes are now used as the internal electrodes of the MLCCs, and in this instance, the nickel internal electrodes are formed from a conductive paste containing nickel metal powder.

The nickel metal powder can be prepared by various preparative processes, and representative processes include a gas phase process and a liquid phase process. The gas phase process is widely used since it is relatively easy to control the morphology of the nickel metal powder and the presence of impurities, yet the process is disadvantageous in the aspects of particle size reduction and mass production. On the other hand, the liquid phase process is advantageous in that mass production is possible and the costs for facilities installation and operation maintenance are low, thus the process being used with favor. The liquid phase process is described in, for example, U.S. Pat. Nos. 4,539,041 and 6,120,576.

However, even when the nickel metal powder is produced by the liquid phase process or the gas phase process, upon the use of the nickel metal powder for the preparation of a conductive paste composition, a large quantity of the nickel metal powder cannot be used because the viscosity of the paste composition may be excessively high. Therefore, a method is known in which the nickel metal powder is dispersed in the paste composition by means of various kinds of dispersants. A dispersant in general exhibits its dispersing ability by adsorbing on the surface of metal powder and suppressing aggregation of the powder. Thus, in order to facilitate adsorption of the dispersant, a dispersant having a functional group which is effective for adsorption, that is, an acidic dispersant, has been used for the nickel metal powder that is basic in nature, so as to disperse the nickel metal powder in the paste. However, there remains a demand for a dispersant having an improved dispersing ability to achieve a satisfactory efficiency of dispersion and to increase the amount of the nickel metal powder contained in the paste composition.

### SUMMARY OF THE DISCLOSURE

It is an aspect of the present disclosure to provide a phosphate dispersant which can improve the efficiency of dispersing metal powder by effectively adsorbing on the surface of the metal powder and preventing aggregation thereof.

It is another aspect of the present disclosure to provide a metal paste composition containing the phosphate dispersant.

It is another aspect of the present disclosure to provide a method of efficiently dispersing metal powder using the phosphate dispersant.

It is yet another aspect of the present disclosure to provide a multilayer ceramic capacitor (MLCC) which contains a metal powder dispersed in the internal electrodes by the dispersion method.

### BRIEF DESCRIPTION OF THE DRAWINGS

The above and other features and advantages of the present invention will be described in detailed exemplary embodiments thereof with reference to the attached drawings in which:

FIG. 1 is a graph showing the NMR results for the phosphate monoester dispersant of Formula 4 according to Example 1 of the present invention, and the starting material;

FIG. 2 is a graph showing the viscosity measurement results for the pastes containing different amounts of the dispersant, prepared according to Example 3 of the present invention;

FIG. 3 is a graph showing the viscosity measurement results for the dispersions according to Example 2, and Comparative Examples 1 through 4; and

FIG. 4 is a diagram illustrating the multilayer ceramic capacitor according to an embodiment of the present invention.

### DETAILED DESCRIPTION OF EXEMPLARY EMBODIMENTS

In order to achieve the technical objects, the present invention provides a phosphate dispersant of the following Formula 1: 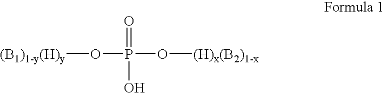
wherein B₁ and B₂ each independently represent a block containing a hydrophilic moiety and a hydrophobic moiety; and

x and y are each independently an integer of 0 or 1, but not being 1 at the same time.

According to an embodiment of the present invention, the phosphate dispersant of Formula 1 may be the phosphate dispersant of the following Formula 2 or Formula 3: 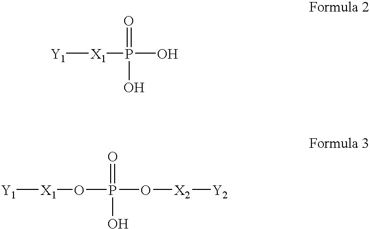
wherein X₁ and X₂ represent identical or different hydrophilic moieties, and Y₁ and Y₂ represent identical or different hydrophobic moieties.

According to an embodiment of the present invention, the hydrophilic moiety may be a heteroalkylene such as, for example, ethylene oxide, while the hydrophobic moiety may be an alkylaryl, an alkylvinyl or the like.

According to an embodiment of the present invention, X₁ of the hydrophilic moiety may be —(OCH₂CH₂)ₘ—, and X₂ of the same part may be —(CH₂CH₂O)ₘ—, while the hydrophobic moiety may be CH₃—(CH₂)ₙ—Ph—, wherein m is an integer of 5 or greater, n is an integer of 4 or greater, and Ph represents a phenyl group.

In order to achieve another technical object, the present invention may provide a conductive paste composition which comprises a nickel metal powder, an organic binder, an organic solvent and a dispersant, wherein the dispersant is the phosphate dispersant of Formula 1.

The amount of the phosphate dispersant of Formula 1 used may be about 0.001 to 1 part by weight based on 100 parts by weight of the nickel metal powder.

In order to achieve another technical object, the present invention may provide a method of dispersing nickel metal powder, which comprises dispersing the nickel metal powder by using the phosphate dispersant of Formula 1.

In order to achieve another technical object, the present invention may provide an MLCC having internal electrodes which contain a nickel metal powder dispersed therein by the dispersion method described above.

Hereinafter, the present invention will be described in more detail.

The surface of nickel metal powder is basic in nature, and thus the dispersibility of the metal powder is improved by using an acidic dispersant. For this purpose, the present invention provides a phosphate dispersant which can effectively adsorb on the surface of the nickel metal powder and thus, has improved dispersing ability, and more particularly, a phosphate dispersant in which the terminal parts are in the form of a block containing a hydrophilic moiety and a hydrophobic moiety.

The phosphate dispersant according to the present invention can be represented by the following Formula (1): 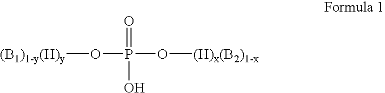
wherein B₁ and B₂ each independently represent a block containing a hydrophilic moiety and a hydrophobic moiety; and

x and y are each independently an integer of 0 or 1, but not being 1 at the same time.

The morphology of the phosphate dispersant of Formula 1 is such that the hydrogen atom of the hydroxyl group present in phosphoric acid (H₃PO₄) is substituted with a block containing a hydrophilic moiety and a hydrophobic moiety. When the hydrophilicity and hydrophobicity of the terminal parts are appropriately adjusted, the phosphate dispersant attains improved adsorption ability against the surface of the nickel metal powder compared to conventional acidic dispersants having a simple structure, and thus, attains an improved dispersing ability.

An example in which the hydrogen atom of a hydroxyl group present in the phosphoric acid is substituted with a block of a hydrophilic moiety and a hydrophobic moiety, is a phosphate monoester of the following Formula 2, and an example in which the hydrogen atoms present in two hydroxyl groups are each substituted with a block of a hydrophilic moiety and a hydrophobic moiety, is a phosphate diester of the following Formula 3: 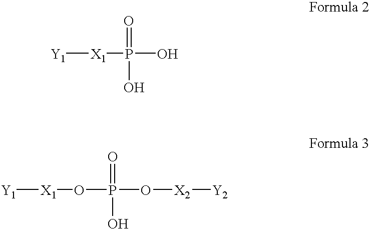
wherein X₁ and X₂ represent identical or different hydrophilic moieties, and Y₁ and Y₂ represent identical or different hydrophobic moieties.

The phosphate ester of Formula 2 or Formula 3 is acidic in nature and thus, can be more effectively adsorbed on the nickel metal powder surface to improve the dispersibility of the metal powder. Furthermore, since the structure of the dispersant is controlled such that a hydrophilic functional group is disposed adjacent to the central phosphorus (P) atom, and a hydrophobic functional group is disposed away from the phosphorus atom, being separated by the hydrophilic group, the adsorption ability of the dispersant to the nickel metal powder is further enhanced, and thus an improvement in the dispersibility of the metal powder is expected.

According to an embodiment of the present invention, the hydrophilic moiety used in the Formula 1 through Formula 3 may be a heteroalkylene. The heteroalkylene is a straight-chained or branched alkylene group having 1 to 30 carbon atoms which contains heteroatoms such as —O—, —N— and —S— in the chain, and a representative example thereof is —(OCH₂CH₂)ₘ—, wherein m is an integer of 5 or greater, preferably in the range of 7 to 15, and most preferably 9. It is more preferable if the oxygen atom at the end of the hydrophilic moiety —(OCH₂CH₂)ₘ— is disposed to be adjacent to the hydrophobic moiety.

According to an embodiment of the present invention, the hydrophobic moiety used in the Formula 1 through Formula 3 may be an alkylaryl, an alkylvinyl or the like. The alkylaryl is in the form of an aryl group in which one or more hydrogen atoms are substituted with a straight-chained or branched alkyl group having 1 to 30 carbon atoms. The alkylaryl may be CH₃—(CH₂)ₙ—Ph—, wherein n is an integer of 4 or greater, and Ph represents a phenyl group, and particularly preferably a nonylphenyl. The alkylvinyl is in the form of a vinyl group in which one or more hydrogen atoms are substituted with a straight-chained or branched alkyl group having 1 to 30 carbon atoms. The alkylvinyl may be, for example, a nonylvinyl.

The phosphate dispersant of Formula 1 according to an embodiment of the present invention is most preferably a compound of the following Formula 4 or Formula 5:

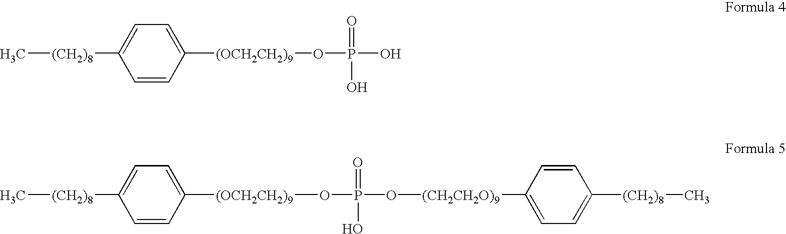

The phosphate dispersant of Formula 1 according to an embodiment of the present invention can be prepared by the procedure shown in the following Reaction Scheme 1: 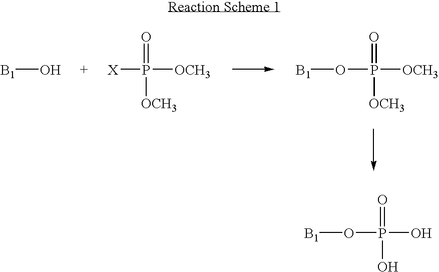
wherein B₁ represents a block containing a hydrophilic moiety and a hydrophobic moiety, and X represents a halogen atom.

A desired phosphate monoester can be prepared by reacting B₁OH with an excess amount of dimethyl halophosphate in an organic solvent such as dichloromethane, in the presence of a base such as triethylamine, to bind B₁ to the phosphate, and then refluxing the product together with BrSi(CH₃)₃ in methanol or refluxing the product in an aqueous sodium hydroxide solution so as to remove protection from the methoxy group by removing a methyl group therefrom.

A phosphate diester can be prepared by carrying out the above process another time to substitute another hydrogen atom with a block containing a hydrophilic moiety and a hydrophobic moiety.

The phosphate dispersant according to an embodiment of the present invention can improve the dispersibility of the nickel metal powder and suppress aggregation of the metal powder particles, and thus, is useful for conductive paste compositions. The conductive paste composition according to an embodiment of the present invention contains a nickel metal powder, an organic binder and an organic solvent. The phosphate dispersant of Formula 1 is further added to the paste composition. The phosphate dispersant of Formula 1 contains a block of a hydrophobic moiety and a hydrophilic moiety in the structure as described above.

The conductive paste composition according to an embodiment of the present invention can employ conventionally known ingredients that are used for the nickel internal electrode of an MLCC, for the components other than the dispersant, while the conductive paste composition of the invention employs the phosphate dispersant of Formula 1 according to the present invention.

The nickel metal powder used in the paste composition can be prepared by a variety of known methods, including the liquid phase method and the solid phase method. The size of the powder particle is also not limited. The organic binder that is suitable for use in the conductive paste composition may be ethylcellulose for example, while the organic solvent may be terpineol, dihydroxy terpineol (DHT), 1-octanol kerosene or the like.

In the conductive paste composition according to an embodiment of the present invention, the amount of the nickel metal powder may be about 30 to 80% by weight, the amount of the organic binder may be about 0.5 to 20% by weight, and the amount of the organic solvent may be about 10 to 50% by weight. The phosphate dispersant according to the present invention is added to the paste composition in an amount of about 0.001 to 1.0 part by weight based on 100 parts by weight of the nickel metal powder. When the amount of the phosphate dispersant is less than about 0.001 parts by weight, satisfactory dispersion cannot be achieved, and when the amount of the phosphate dispersant is more than about 1 part by weight, the dispersant present in excess causes an increase in the paste viscosity, which is not desirable. In the relationship regarding the amounts of other materials, when the amount of the organic binder is less than about 1% by weight, the function of the binder is insufficient, and when the amount exceeds about 20% by weight, the viscosity is undesirably high. When the amount of the organic solvent is less than about 10% by weight, the viscosity is high, and when the amount exceeds about 60% by weight, the conductivity of the paste composition may be lowered.

However, the composition as described above is only an illustrative example of preferred embodiments, and it should be noted that a person having ordinary skill in the art would understand that the composition can be varied depending on the use of the paste composition. In particular, the phosphate dispersant according to an embodiment of the present invention is advantageous in that the phosphate dispersant allows an improvement in the dispersion efficiency and thus, allows using a larger amount of nickel metal powder without a significant increase in the paste viscosity.

The conductive paste composition according to the present invention can further contain additives such as, for example, a plasticizer, an anti-thickening agent and other dispersants. The conductive paste composition of the present invention may be prepared by using any of various known methods.

According to another embodiment of the present invention, a dispersion method of dispersing a nickel metal powder by using the phosphate dispersant according to the invention is provided. The dispersion method comprises dispersing a nickel metal powder together with an organic binder in an organic solvent, using the phosphate dispersant according to the present invention as described above. The advantage of the dispersion method is that aggregation of the nickel metal powder is maximally suppressed, and thus a large amount of the nickel metal powder can be used without an increase in the viscosity, as described above.

According to another embodiment of the present invention, an MLCC having nickel internal electrodes is provided, wherein the nickel internal electrodes contain a nickel metal powder dispersed by the above dispersion method. In view of the characteristics of an electrode, since a nickel internal electrode having a dense structure is excellent in the electric properties or mechanical properties, an electrode containing a large amount of the nickel metal powder as possible is preferred. The nickel internal electrode containing a nickel metal powder which is dispersed by the dispersion method of using the phosphate dispersant according to the present invention is such that, the electrode-forming paste can contain a larger amount of the nickel metal powder compared to conventional nickel internal electrodes, at a high concentration without an increase in the viscosity, while containing the same amounts of an organic solvent and an organic binder. As a result, the nickel internal electrode obtained by applying and sintering the paste has an improved quality. That is, when the degree of filling of the electrode-forming nickel metal powder increases, breakage of the electrode or reduction in the electric resistance can be suppressed, and damage in the electrode due to an external shock can be prevented.

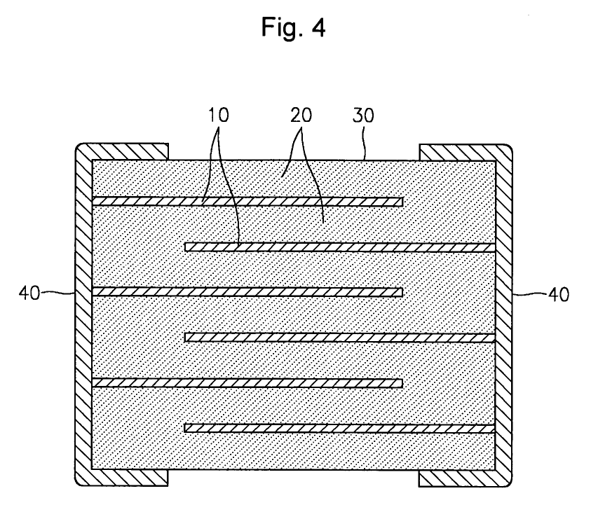

FIG. 4 illustrates an MLCC according to an embodiment of the present invention. The MLCC shown in FIG. 10 consists of a laminate 30 composed of internal electrodes 10 and dielectric layers 20, and terminal electrodes 40. The internal electrodes 10 are formed such that the electrode tips are exposed from one side of the laminate 30 so as to be in contact with the terminal electrode at either side.

An exemplary method of producing the MLCC of the present invention is set forth hereafter. A paste for the formation of dielectric layers which contains a dielectric material, and the conductive paste of the present invention are printed alternately. The resulting laminate is sintered. The conductive paste is applied to the cross-sections of the laminate 30 so that the tips of the internal electrodes 10 which are exposed from the cross-sections of the sintered laminate 30, and the applied conductive paste are brought to electrical and mechanical bonding, and then the applied conductive paste is sintered to form terminal electrodes 40.

The MLCC according to the present invention is not limited to the embodiment illustrated in FIG. 4 and can have various morphologies, dimensions, layer numbers, circuit constitutions and the like.

### EXAMPLES

The present invention will now be described with reference to the following examples, which are for illustrative purposes only and not intended to limit the scope of the present invention.

### Example 1

A phosphate dispersant of the following Formula 4 was prepared by carrying out the process illustrated in the following Reaction Scheme 2:

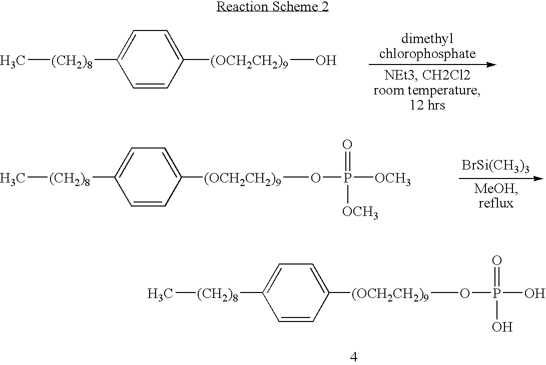

In the above reaction, dimethyl chlorophosphate was added in excess of about 5 equivalents based on the starting material. The yield of the binding reaction in the first process was about 99%, and the yield of the protection removal reaction in the second process was about 80%.

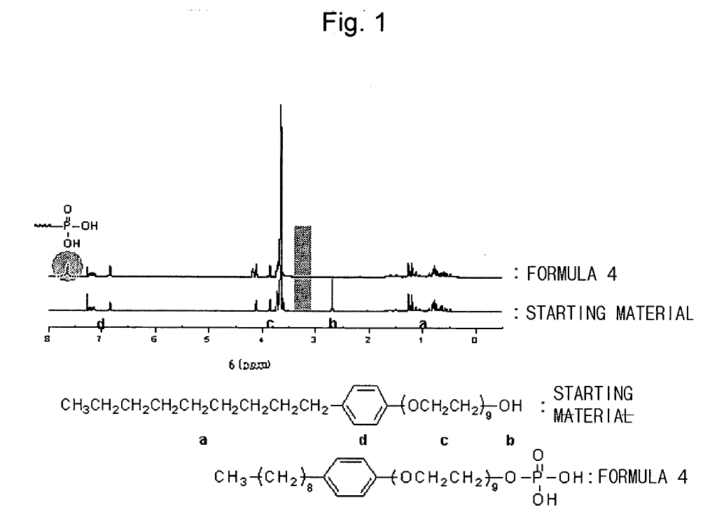

The NMR results for the final product and the starting material are shown in FIG. 1. As can be seen from the results of FIG. 1, a peak corresponding to a methoxy attached to phosphate, which was absent in the starting material, was observed at 3.8 ppm in the compound of Formula 4, the final product. Thus, it was confirmed that the final product of Formula 4 was obtained as a result of conversion of the hydroxyl (OH) group of the starting material to a phosphate group.

### Example 2

27.93 g of a nickel metal powder (average particle size: 0.5 μm, supplier: Shoei Co., Ltd., Japan, product name: Ni-670) was added to 18.68 g of an organic solution containing ethyl cellulose (EC) and dihydroxy terpineol (DHT) at a weight ratio of 1:10, to form a liquid mixture. Then, about 1 part by weight of the phosphate monoester dispersant of Formula 4, based on 100 parts by weight of the nickel metal powder, was added thereto. Subsequently, the resulting liquid mixture was stirred with a stirrer to disperse the nickel metal powder, and a nickel paste was obtained.

### Example 3

27.93 g of a nickel metal powder (average particle size: 0.5 μm, supplier: Shoei Co., Ltd., Japan, product name: Ni-670) was added to 18.68 g of an organic solution containing EC and DHT at a weight ratio of 1:10, to form a liquid mixture. Then, the phosphate monoester dispersant of Formula 4 was added thereto, while varying the amount of the dispersant added as shown in Table 1 below, based on 100 parts by weight of the nickel metal powder. Subsequently, the resulting liquid mixtures were stirred with a stirrer to disperse the nickel metal powder, and nickel pastes were obtained.

TABLE 1

| EC + | Nickel Metal | |
|---|---|---|
| DHT (g) | Powder (g) | Dispersant (part by weight) |
| 18.68 | 27.93 | 0.14 g (0.5 parts by weight) |
| | | 0.28 g (1 part by weight) |
| | | 0.42 g (1.5 parts by weight) |
| | | 0.56 g (2 parts by weight) |
| | | 0.84 g (3 parts by weight) |

### Comparative Example 1

A dispersion was prepared in the same manner as in Example 2, except that CH₃(CH₂)₆CH₂CH═CHCH₂(CH₂)₆CH₂OH (oleyl alcohol) was used instead of the phosphate monoester dispersant of Formula 4.

### Comparative Example 2

A dispersion was prepared in the same manner as in Example 2, except that CH₃(CH₂)₆CH₂CH═CHCH₂(CH₂)₆CH₂NH₂ (oleyl amine) was used instead of the phosphate monoester dispersant of Formula 4.

### Comparative Example 3

A dispersion was prepared in the same manner as in Example 2, except that CH₃(CH₂)₆CH₂CH═CHCH₂(CH₂)₅CH₂CO₂H (oleic acid) was used instead of the phosphate monoester dispersant of Formula 4.

### Comparative Example 4

A dispersion was prepared in the same manner as in Example 2, except that oleoyl sarcosine was used instead of the phosphate monoester dispersant of Formula 4.

### Experimental Example 1

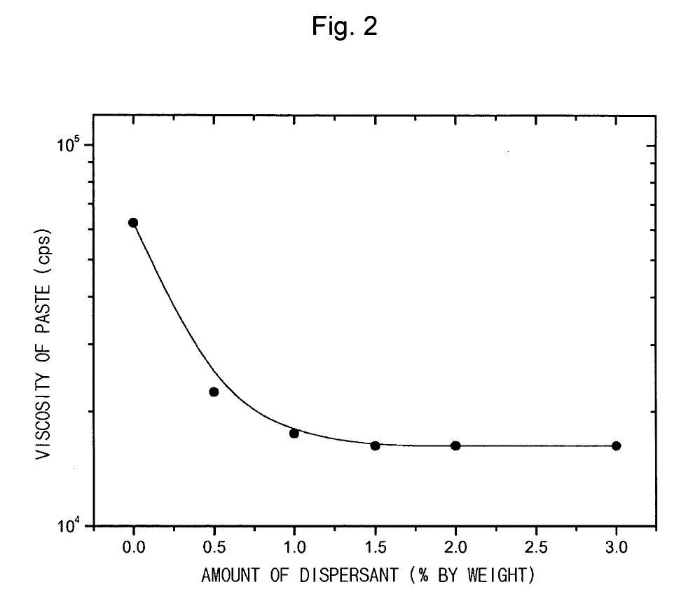

The viscosities of the dispersions having different amounts of dispersant that were obtained in Example 3 were measured to evaluate the dispersing ability of the dispersant. The results are presented in FIG. 2. A Brookfield viscometer Model RVII was used, and a No. 14 spindle of the cylinder type was used. The temperature was 25° C.

As can be seen from the results of FIG. 2, the phosphate dispersant according to the present invention exhibits satisfactory dispersing ability when contained in an amount of about 1.0 part by weight or less based on 100 parts by weight of the nickel metal powder. When the amount increases, the enhancement of the dispersing ability is not so significant.

### Experimental Example 2

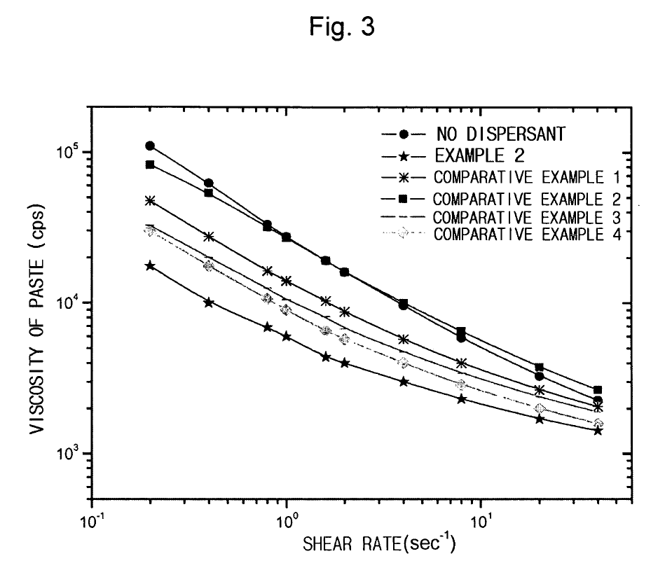

For a comparison with conventional dispersants, the viscosities of the dispersions obtained in Example 2 and Comparative Examples 1 through 4 were measured to evaluate the dispersing ability of the dispersants. The results are presented in FIG. 3. A Brookfield viscometer Model RVII was used, and a No. 14 spindle of cylinder type was used. The temperature was 25° C.

As can be seen from the results of FIG. 3, the dispersion according to Example 2, which used the phosphate monoester of Formula 4 according to the present invention, had the best dispersing ability.

In general, as the viscosity of the dispersion decreases, the packaging factor of the nickel metal powder increases, and subsequently the film density of the nickel electrode increases. This results in enhanced conductivity and improved performance of the MLCC element. When the amount of the nickel metal powder added is increased by adding the dispersant according to the present invention, the film density of the nickel electrode is improved, compared to the instance where no dispersant is added or the instance where conventional dispersants are added, and thus an MLCC element having electrodes of excellent quality can be provided.

The phosphate dispersant according to the present invention contains a hydrophobic moiety and a hydrophilic moiety and thus, can achieve the optimal dispersion efficiency. An improvement in the dispersion efficiency as such allows suppression of aggregation of the nickel metal powder upon preparation of a conductive paste composition, and therefore a larger amount of the nickel metal powder can be used in the paste composition. The enhanced amount of the nickel metal powder enables production of an internal nickel electrode having improved electrical properties and mechanical properties during the production of MLCCs.

What is claimed is:

1. A phosphate dispersant having the structure of the following Formula 1: 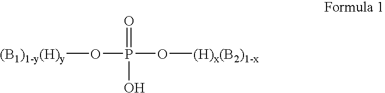
wherein B₁ and B₂ each independently represent a block containing a hydrophilic moiety and a hydrophobic moiety; and
x and y are each independently an integer of 0 or 1, but not being 1 at the same time.

2. The phosphate dispersant of claim 1, having the structure of the following Formula 2 or Formula 3: 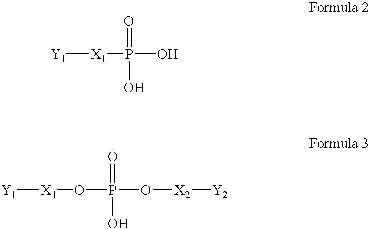
wherein X₁ and X₂ represent identical or different hydrophilic moieties; and
Y₁ and Y₂ represent identical or different hydrophobic moieties.

3. The phosphate dispersant of claim 1, wherein the hydrophilic moiety is a heteroalkylene.

4. The phosphate dispersant of claim 1, wherein the hydrophobic moiety is an alkylaryl or an alkylvinyl.

5. The phosphate dispersant of claim 2, wherein the hydrophilic moiety X₁ is —(OCH₂CH₂)ₘ—, and the hydrophilic moiety X₂ is —(CH₂CH₂O)ₘ—, wherein m is an integer of 5 or greater.

6. The phosphate dispersant of claim 2, wherein the hydrophobic moiety is CH₃—(CH₂)ₙ—Ph—, wherein n is an integer of 4 or greater, and Ph is a phenyl group.

7. A compound of the following Formula 1: 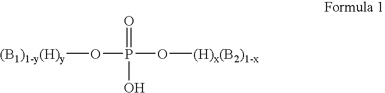
wherein B₁ and B₂ each independently represent a block containing a hydrophilic moiety and a hydrophobic moiety; and
x and y are each independently an integer of 0 or 1, but not being 1 at the same time

8. The compound of claim 7, which is a compound of the following Formula 2 or Formula 3: 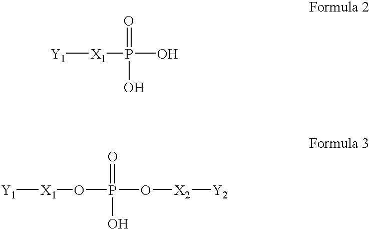
wherein X₁ and X₂ are identical or different heteroalkylenes; and
Y₁ and Y₂ are identical or different alkylaryls or alkylvinyls.

9. The compound of claim 8, wherein X₁ is —(OCH₂CH₂)ₘ—, and X₂ is —(CH₂CH₂O)ₘ—, wherein m is an integer of 5 or greater, while Y₁ and Y₂ are each —CH₃—(CH₂)ₙ—Ph—, wherein n is an integer of 4 or greater, and Ph is a phenyl group.

10. A conductive paste composition containing a nickel metal powder, an organic binder, an organic solvent and a dispersant, wherein the dispersant is the phosphate dispersant of claim 1.

11. The conductive paste composition of claim 10, wherein the amount of the phosphate dispersant is about 0.001 to 1.0 part by weight based on 100 parts by weight of the nickel metal powder.

12. A method of dispersing nickel metal powder, comprising dispersing a nickel metal powder using the phosphate dispersant of claim 1.

13. A multilayer ceramic condenser including internal electrodes which contain a nickel metal powder dispersed therein by the method of claim 12.

14. A conductive paste composition containing a nickel metal powder, an organic binder, an organic solvent and a dispersant, wherein the dispersant is the phosphate dispersant of claim 2.

15. A conductive paste composition containing a nickel metal powder, an organic binder, an organic solvent and a dispersant, wherein the dispersant is the phosphate dispersant of claim 3.

16. The conductive paste composition of claim 14, wherein the amount of the phosphate dispersant is about 0.001 to 1.0 part by weight based on 100 parts by weight of the nickel metal powder.

17. The conductive paste composition of claim 15, wherein the amount of the phosphate dispersant is about 0.001 to 1.0 part by weight based on 100 parts by weight of the nickel metal powder.

18. A method of dispersing nickel metal powder, comprising dispersing a nickel metal powder using the phosphate dispersant of claim 2.

19. A method of dispersing nickel metal powder, comprising dispersing a nickel metal powder using the phosphate dispersant of claim 3.

20. A multilayer ceramic condenser including internal electrodes which contain a nickel metal powder dispersed therein by the method of claim 18.

21. A multilayer ceramic condenser including internal electrodes which contain a nickel metal powder dispersed therein by the method of claim 19.
